(19) United States
(12) Patent Application Publication
(10) Pub. No.: US 2024/0253715 A1
(43) Pub. Date: Aug. 1, 2024

(54) REINFORCEMENT MEMBER FOR AN ENDLESS TRACK AND ENDLESS TRACK INCLUDING THE REINFORCEMENT MEMBER

(71) Applicant: SOUCY INTERNATIONAL INC., Drummondville (CA)

(72) Inventors: Yves SAUVAGEAU, Drummondville (CA); Eric HALSTEAD, Sainte-Marie-Madeleine (CA); Maxime MOISAN, Drummondville (CA)

(21) Appl. No.: 18/561,118

(22) PCT Filed: Feb. 28, 2023
(86) PCT No.: PCT/CA2023/050256

§ 371 Date: Nov. 15, 2023

Related U.S. Application Data
(60) Provisional application No. 63/316,174, filed on Mar. 3, 2022.

(51) Int. Cl. B62D 55/24

(52) U.S. Cl. CPC B62D 55/244

(57) ABSTRACT

A reinforcement member for an endless track comprises a flat, tubular and elongated body having upper and lower faces that each have a depth and a length greater than the depth, a central portion, and a lateral arm extending from each side thereof. Another reinforcement member comprises an elongated body made of an elastically deformable material, a major portion of the elongated body being flat, one or more protrusion projecting vertically from an upper face of the elongated body, the protrusion defining a peak extending parallel to a depth of the upper face. Yet another reinforcement member comprises an elongated body having a depth and a length greater than the depth, a bottom section being generally flat with rounded elongated edges defined along the length, a top section having a convex outline defined along the depth, the top section being tapered at opposite ends of the reinforcement member.

### CROSS-REFERENCE

The present application claims priority from U.S. Provisional Patent Application Ser. No. 63/316,174, filed on Mar. 3, 2022, the disclosure of which is incorporated by reference herein in its entirety.

### FIELD OF TECHNOLOGY

The present technology relates to a reinforcement member for an endless track and to an endless track including the reinforcement member.

### BACKGROUND

Certain vehicles, such as, for example, agricultural vehicles (e.g., harvesters, combines, tractors, etc.), construction vehicles (e.g., bulldozers, front-end loaders, etc.), side-by-side vehicles (SBSV), all-terrain vehicles (ATV) and utility task vehicles (UTV) are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces and, as these vehicles are generally heavy, the tires may compact the ground surface in an undesirable way owing to the weight of the vehicle.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable these vehicles to be used in wet field conditions as opposed to its wheeled counterpart.

Conventionally, endless tracks for industrial or construction vehicles can be made of metallic members or can be made of an elastomeric material with rigid laterally extending reinforcement members. Early examples of such reinforcement members are disclosed in U.S. Pat. No. 7,784,884 B2 to Soucy et al., issued on Aug. 31, 2010, the disclosure of which is incorporated by reference herein in its entirety. Endless tracks equipped with such reinforcement members can last longer than endless tracks without reinforcements, but their lifetime is still limited, particularly as they tend to wear on their outer edges. Reinforcement members typically being made of forged steel can be very heavy and thus can require a relatively large amount of energy to move. As more and more vehicles will use batteries to power electric motors, it will become increasingly important to reduce power consumption. Additionally, conventional endless tracks can induce vibrations within the endless track, these vibrations reducing a maximum speed at which a vehicle to which the endless track is connected can travel.

Therefore, there is a desire for a reinforcement member and for an endless track that could mitigate at least some of the above-mentioned issues.

### SUMMARY

In a first aspect, various implementations of the present technology provide a reinforcement member for an endless track, comprising: a flat, tubular and elongated body having: an upper face, a lower face opposite from the upper face, each of the upper and lower faces having a depth and a length greater than the depth, a central portion and a lateral arm extending from each side thereof.

In some implementations of the present technology, the reinforcement member is made of a metallic material.

In some implementations of the present technology, the metallic material is one of aluminum and high strength steel alloy.

In some implementations of the present technology, the reinforcement member is formed by stamping a unitary metal sheet so that opposite long edges of the metal sheet are brought in proximity to one another to form a junction along the length on the lower face of the reinforcement member.

In some implementations of the present technology, the junction forms a gap between the opposite long edges of the metal sheet, a width of the gap being less than a thickness of the metal sheet.

In some implementations of the present technology, each of the upper and lower faces forms a generally rectangular perimeter.

In some implementations of the present technology, at least one of the upper face and the lower face includes an elongated bulge.

In some implementations of the present technology, the elongated bulge on the at least one of the upper face and the lower face comprises: a central portion having a first width extending along a major portion of the depth of the upper or lower face of the reinforcement member; and a pair of opposite ends extending away from the central portion, a second width of the opposite ends being smaller than the first width.

In some implementations of the present technology, a perimeter of the elongated bulge on the at least one of the upper face and the lower face is tapered between the central portion and each of the opposite ends.

In some implementations of the present technology, each of the opposite ends converges to form a tip.

In some implementations of the present technology, a height of an internal opening of the flat tubular and elongated body is in a range between about one time and about five times a thickness of the metal sheet.

In some implementations of the present technology, the reinforcement member further comprises a pair of elongated grooves formed on both sides of the junction on the lower face of the reinforcement member.

In some implementations of the present technology, the reinforcement member further comprises a pair of apertures extending through the upper and lower faces of the reinforcement member, the apertures being located proximal to distal ends of the reinforcement member.

In some implementations of the present technology, the flat, tubular and elongated body defines a pair of opposite curved and elongated surfaces joining the upper and lower faces of the reinforcement member.

In some implementations of the present technology, the reinforcement member further comprises a plate disposed on top of the elongated body, the plate defining at least one protrusion projecting substantially vertically from the upper face of the reinforcement member, the at least one protrusion defining a peak extending parallel to the depth of the upper face of the reinforcement member.

In some implementations of the present technology, the at least one protrusion comprises a single protrusion

In some implementations of the present technology, the single protrusion is positioned centrally along a length of the upper face of the reinforcement member.

In some implementations of the present technology, the single protrusion is positioned on a left or right side of a central position defined along a length of the upper face of the reinforcement member.

In some implementations of the present technology, the at least one protrusion comprises two protrusions, the two protrusions being equidistant from a central position defined along a length of the upper face of the reinforcement member.

In some implementations of the present technology, the plate is welded on the upper face of the reinforcement member.

In some implementations of the present technology, the plate is formed by stamping a unitary metal plate so that each of the at least one protrusion has an inverted V-shape extending from flat sections of the plate.

In some implementations of the present technology, the plate is made of a material selected from Ultra High Molecular Weight (UHMW), other plastics, nylon, fiber reinforced resin, other composites, rigid rubber and any combination thereof.

In some implementations of the present technology, a central portion of the plate is located on a central position defined along the length of the upper face of the reinforcement member; two first opposite ends of the plate are folded so that two protrusions project vertically from the upper face of the reinforcement member; and two second opposite ends of the plate are curved to wrap around edges of the upper face of the reinforcement member toward the lower face of the reinforcement member.

In some implementations of the present technology, two stubs are formed by raising portions on the elongated body, the two stubs being in contact with external faces of the first two opposite ends of the plate for maintaining a position of the plate on the reinforcement member.

In some implementations of the present technology, the reinforcement member is configured for receiving one or more reinforcing cables extending parallel to the depth of the upper and lower faces of the reinforcement member.

In a second aspect, various implementations of the present technology provide a reinforcement member for an endless track, comprising: an elongated body made of an elastically deformable material, a major portion of the elongated body being flat; at least one protrusion projecting vertically from an upper face of the elongated body; the elongated body having a depth and a length greater than the depth; the at least one protrusion defining a peak extending parallel to the depth of the upper face of the elongated body.

In some implementations of the present technology, the reinforcement member forms a generally rectangular perimeter.

In some implementations of the present technology, the elongated body is formed by stamping a unitary metal sheet.

In some implementations of the present technology, the at least one protrusion comprises a single protrusion positioned centrally along the length of the upper face of the elongated body.

In some implementations of the present technology, the at least one protrusion comprises a single protrusion positioned on a left or right side of a central position defined along the length of the upper face of the elongated body.

In some implementations of the present technology, the at least one protrusion comprises two protrusions, the two protrusions being equidistant from a central position along the length of the upper face of the elongated body.

In some implementations of the present technology, the elastically deformable material is selected in accordance with a load case and dimensioning parameters of the endless track.

In a third aspect, various implementations of the present technology provide a reinforcement member for an endless track, comprising: an elongated body having a depth and a length greater than the depth; a bottom section of the reinforcement member being generally flat with rounded elongated edges defined along the length; a top section of the reinforcement member having a convex outline defined along the depth; the top section of the reinforcement member being tapered at opposite ends of the reinforcement member.

In some implementations of the present technology, the elongated body forms a generally rectangular perimeter.

In some implementations of the present technology, the reinforcement member is made of a material selected from a Ultra High Molecular Weight (UHMW), other plastics, nylon, fiber reinforced resin, other composites, rigid rubber and any combination thereof.

In some implementations of the present technology, the top section is made of a first material and the bottom section is made of a second material different from the first material.

In some implementations of the present technology, the first material is steel and the second material is fiberglass.

In some implementations of the present technology, the reinforcement member further comprises a plate mounted on the top section; a central portion of the plate being located on a central position defined along the length of the elongated body; two first opposite ends of the plate being folded so that two protrusions project substantially vertically from the top section of the reinforcement member; and two second opposite ends of the plate being curved to wrap around edges of the top section of the reinforcement member toward the bottom section of the reinforcement member.

In some implementations of the present technology, the plate is formed by stamping a unitary metal plate.

In a fourth aspect, various implementations of the present technology provide an endless track for a tracked vehicle, the track being disposed around at least a driving wheel assembly and a plurality of idler wheel assemblies, the endless track comprising: an inner surface engageable by the driving wheel assembly and by the idler wheel assemblies, an outer surface engageable to a ground surface, one or more lugs projecting from the inner surface and configured to transmit driving power from the driving wheel assembly to the endless track, and one or more reinforcement members as defined hereinabove, each reinforcement member being embedded in a carcass of the endless track, the length of the reinforcement member being oriented along a track width of the endless track, each reinforcement member being aligned with a corresponding one of the one or more lugs.

In some implementations of the present technology, the endless track is mainly made of an elastomeric material.

In some implementations of the present technology, the tracked vehicle is selected from a compact tracked loader, a tracked skid-steer, an excavator, a bulldozer, an agricultural tractor, a harvester, a combine, a side-by-side vehicle, an all-terrain vehicle, a utility task vehicle, and a military vehicle.

In some implementations of the present technology, the tracked vehicle is selected from a light-duty work vehicle, a medium-duty work vehicle and a heavy-duty work vehicle.

In a fifth aspect, various implementations of the present technology provide a track system for a vehicle, the track system comprising a frame; a track-engaging assembly connected to the frame; and an endless track as defined hereinabove disposed around the frame and the track-engaging assembly, the track-engaging assembly including: a driving wheel assembly operatively connectable to a driving axle of the vehicle for driving the endless track, and a plurality of idler wheel assemblies.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1a is a front, right perspective view of a military vehicle having a track system with an endless track;

FIG. 1b is front, left perspective view of a compact track loader having a track system with an endless track;

FIG. 1c is left side elevation view of a recreational vehicle having a track system with an endless track;

FIG. 2 is a right side elevation view of a track system of the compact track loader of FIG. 1b;

FIGS. 3a, 3b and 3c are perspective, detailed views of the sprocket wheel assemblies of FIGS. 1a, 1b and 1c, respectively;

FIG. 4 is a perspective view taken from a top, rear, right side of a portion of an endless track;

FIG. 5 is a perspective view taken from a top, rear, right side of the endless track of FIG. 4, with features of the endless track being shown in transparency;

FIG. 6 is a bottom view of an outer surface of the endless track of FIG. 4, with features of the endless track being shown in transparency;

FIG. 7a is a top perspective view of a conventional reinforcement member;

FIG. 7b is a front elevation view of the conventional reinforcement member of FIG. 7a shown in transparency as installed in an endless track;

FIG. 8a is a top perspective view of another conventional reinforcement member having longer protrusions;

FIG. 8b is a front elevation view of the conventional reinforcement member of FIG. 8a shown in transparency as installed in an endless track;

FIG. 9a is a top perspective view of another, wider conventional reinforcement member;

FIG. 9b is a front elevation view of the conventional reinforcement member of FIG. 9a shown in transparency as installed in an endless track;

FIG. 10a is a top perspective view of reinforcement member in accordance with a first embodiment of the present disclosure;

FIG. 10b is a front elevation view of the reinforcement member of FIG. 10a shown in transparency as installed in an endless track;

FIG. 11a is a top perspective view of reinforcement member in accordance with a second embodiment of the present disclosure;

FIG. 11b is a front elevation view of the reinforcement member of FIG. 11a shown in transparency as installed in an endless track;

FIG. 12a is a top perspective view of reinforcement member in accordance with a third embodiment of the present disclosure;

FIG. 12b is a front elevation view of the reinforcement member of FIG. 12a shown in transparency as installed in an endless track;

FIG. 13a is a top perspective view of reinforcement member in accordance with a fourth embodiment of the present disclosure;

FIG. 13b is a front elevation view of the reinforcement member of FIG. 13a shown in transparency as installed in an endless track;

FIG. 14a is a top perspective view of reinforcement member in accordance with a fifth embodiment of the present disclosure;

FIG. 14b is a front elevation view of the reinforcement member of FIG. 14a shown in transparency as installed in an endless track;

FIG. 15a is a top perspective view of reinforcement member in accordance with a sixth embodiment of the present disclosure;

FIG. 15b is a front elevation view of the reinforcement member of FIG. 15a shown in transparency as installed in an endless track;

FIG. 16a is a top perspective view of reinforcement member in accordance with a seventh embodiment of the present disclosure;

FIG. 16b is a front elevation view of the reinforcement member of FIG. 16a shown in transparency as installed in an endless track; and

FIGS. 17a-17e show additional details of some embodiments of the reinforcement member.

Like numerals represent like features on the various drawings. Unless otherwise mentioned, the Figures are not to scale.

### DETAILED DESCRIPTION

Embodiments of the present technology each have at least one of the below-mentioned objects and/or aspects, but do not necessarily have all of them. It should be understood that some aspects of the present technology that have resulted from attempting to attain the below-mentioned object may not satisfy this object and/or may satisfy other objects not specifically recited herein.

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of the terms “including”, “comprising”, “having”, “containing”, “involving” and variations thereof herein, is meant to encompass the items listed thereafter as well as, optionally, additional items.

As used herein, the singular form “a”, “an” and “the” include plural referents unless the context clearly dictates otherwise.

The recitation herein of numerical ranges by endpoints is intended to include all numbers subsumed within that range (e.g., a recitation of 1 to 5 includes 1, 1.5, 2, 2.75, 3, 3.80, 4, 4.32, and 5).

The term “about” is used herein explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. For example, the term “about” in the context of a given value or range refers to a value or range that is within 20%, preferably within 15%, more preferably within 10%, more preferably within 9%, more preferably within 8%, more preferably within 7%, more preferably within 6%, and more preferably within 5% of the given value or range.

The expression “and/or” where used herein is to be taken as specific disclosure of each of the two specified features or components with or without the other. For example, “A and/or B” is to be taken as specific disclosure of each of (i) A, (ii) B and (iii) A and B, just as if each is set out individually herein.

Additional and/or alternative features, aspects, and advantages of embodiments of the present technology will become apparent from the following description, the accompanying drawings.

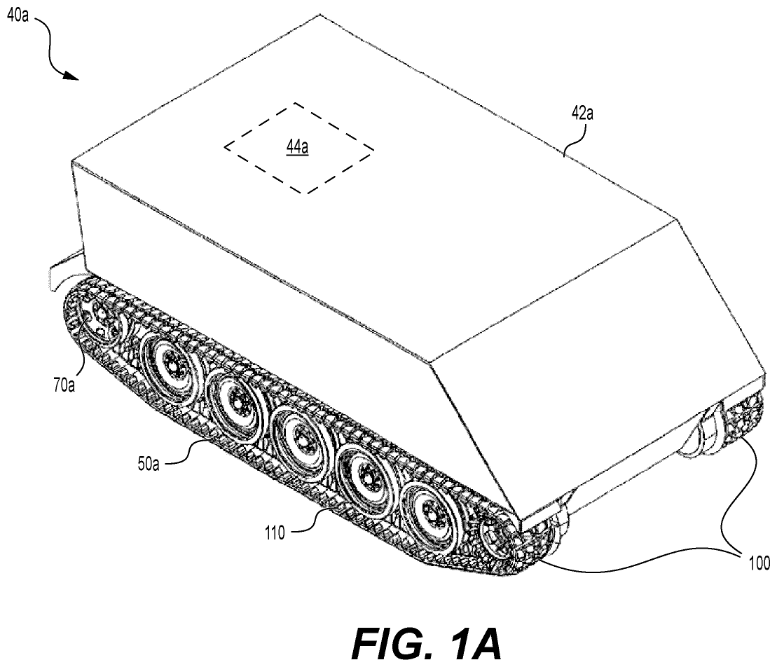

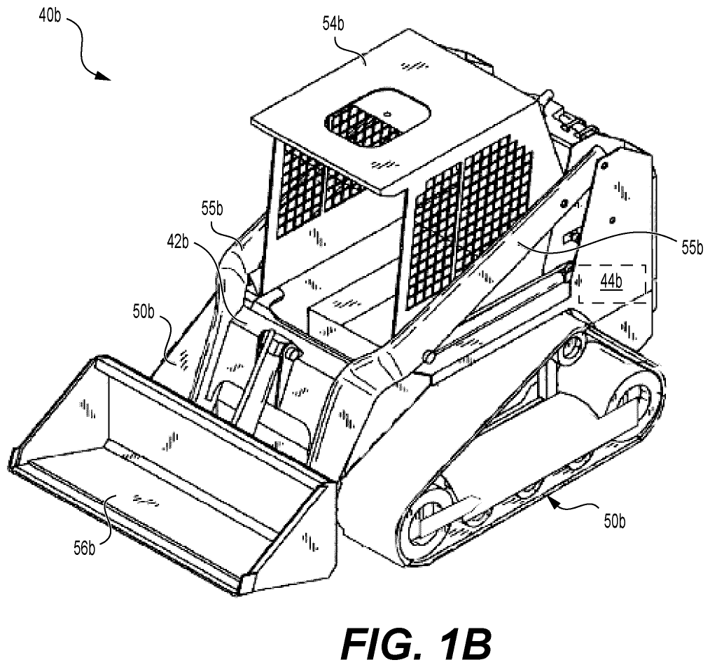

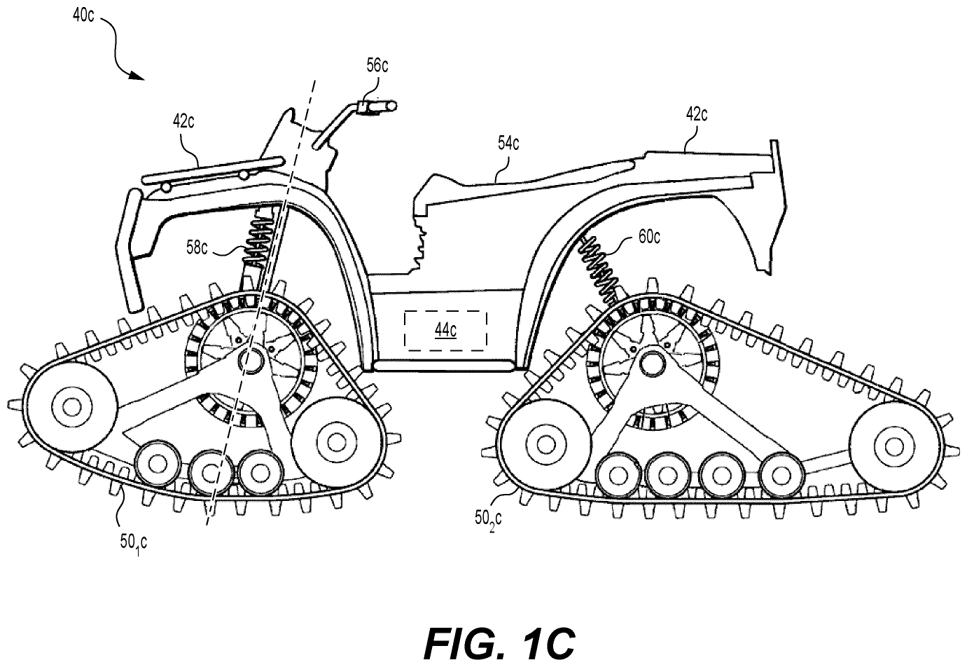

The present technology relates to an endless track which is mountable to a track system. In some instances, the endless track is for replacing a conventional endless track, for example a metallic endless track, mounted to a track system of a vehicle. The endless track will be described with reference to a work vehicle, such as a Compact Tracked Loader (CTL). However, it is contemplated that the endless track could be used with other types of work vehicles, such as but not limited to, industrial/construction vehicles (tracked skid-steers, excavators, bulldozers, etc.), agricultural vehicles (tractors, harvesters, etc.), powersports vehicles (ATVs, UTVs, SBSVs, etc.), and military vehicles; some of these being shown on FIGS. 1a, 1b and 1c. It is also contemplated that in some embodiments, the endless track could be used with light-duty work vehicles, medium-duty work vehicles and/or heavy-duty work vehicles. It is contemplated that light-duty vehicles could weigh between about 3,000 lbs and about 19,500 lbs, medium-duty vehicles could weight between about 19,500 lbs and about 33,000 lbs and heavy-duty vehicles could weight more than about 33,000 lbs. A person skilled in the art will understand that the mentioned weights are given for exemplary purposes and can vary on a case-by-case basis. It is further contemplated that in some embodiments, the present technology could be used with other types of vehicles.

The endless track may for example be an elastomeric track having a carcass, a pair of belting members being disposed within the carcass and extending over the entire endless track. In some embodiments, the endless track consists essentially of elastomeric material. In some embodiments, the endless track is made of at least about 90% polymeric material (i.e., carcass) and less than about 10% other material (i.e., belting members). In other embodiments, the endless track is made of at least about 95% polymeric material (i.e., carcass) and less than about 5% other material (i.e., belting member). In yet other embodiments, the endless track is made of at least about 98% polymeric material (i.e., carcass) and less than about 2% other material (i.e., belting members). In yet other embodiments, the endless track is made of at least about 99% polymeric material (i.e., carcass) and less than about 1% other material (i.e., belting members).

The carcass has an inner surface, an outer surface, a plurality of lugs extending from the inner surface, and traction projections (or thread lugs) extending from the outer surface. The carcass, further has a width generally measured between its left and right edges.

Referring to FIG. 1a, a military vehicle 40a is shown. The military vehicle 40a has a body 42a that houses an engine 44a (shown schematically). The military vehicle 40 also has left and right track systems 50a (only the right track system 50a is shown). Each track system 50a includes a driving wheel assembly 70a and an endless track 100 having a plurality of lugs 110 on its internal face. It is contemplated that in some embodiments, the military vehicle 40a could have more than two track systems, and/or left and right wheels. In some embodiments, the engine 44a is operatively connected to left and right track systems 50a. It is contemplated that in some embodiments, the engine 44a could be operatively connected to wheels. In the same or other embodiments, the track systems 50a may be connected to free (non-driving) axles that are not powered by the engine 44a. It is therefore understood that the present technology could be used with other vehicles such as trailers, carts, etc.

Referring to FIG. 1b, an embodiment of work vehicle, for example a compact track loader 40b, will be described. The compact track loader 40b has a body 42b that houses an engine 44b (shown schematically). A cab 54b extends upwardly from the body 42b. The compact track loader 40b also has loader arms 55b pivotally and operationally connected to the body 42b. A bucket 56b is connected at a front end of the loader arms 55b. Thus, when the loader arms 55b are operated, the bucket 56b can be moved. The compact track loader 40b also has track systems 50b disposed on the left and right sides of the body 42b (the track system 50b on the right side is only partially shown in FIG. 1b). The left and right track systems 50b are operationally connected to the compact track loader 40b. In some embodiments, the engine 44b is operatively connected to left and right track systems 50b. The compact track loader 40b is a light heavy-duty vehicle.

Referring to FIG. 1c, an all-terrain vehicle (ATV) 40c has a body 42c, an engine 44c (schematically shown) mounted in the body 42c, a straddle seat 54c mounted on top of the body 42c, a steering system 56c, front a rear suspensions 58c and 60c that respectively connect front and rear track systems 501c and 502c to the body 42c. One or both of the front and rear track systems 501c and 502c is driven by the engine 44c.

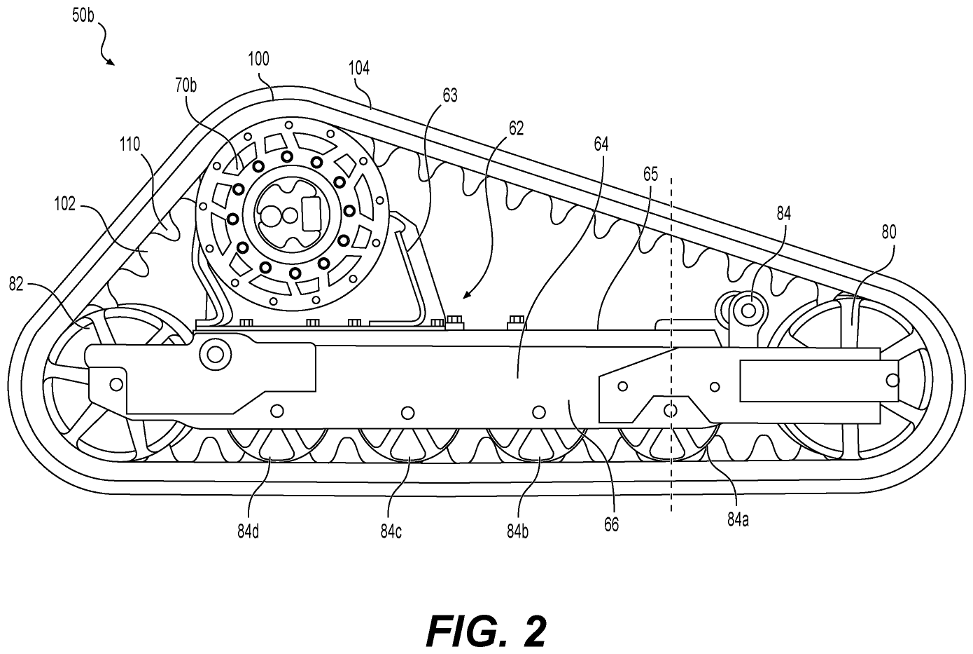

The various vehicles 40a, 40b and 40c and their respective track systems 50a, 50b, 501c and 502c share many characteristics and differ in other characteristics. For illustration purposes, the track system 50b of the compact track loader 40b will now be described by reference to FIGS. 1b and 2. The track system 50b has frame 62 that has an upper frame section 63 and a lower frame section 64, and generally extends in the longitudinal direction of the track system 50b. The lower frame section 64 has a top frame portion 65, and lateral frame portions 66 extending downwardly from the top frame portion 65, one lateral frame portion 66 being present on both left and right sides of top frame portion 65.

The track system 50b also has a sprocket-type driving wheel assembly 70b that is rotationally connected to the frame 62. More precisely, the driving wheel assembly 70b is rotationally connected to the upper frame section 63. The driving wheel assembly 70b is also operatively connected to a driving axle (not shown) of the compact track loader 40b.

The track system 50b has a front idler wheel assembly 80 and a rear idler wheel assembly 82, both of which are rotationally connected to the frame 62. More precisely, the front and rear idler wheel assemblies are rotationally and removably connected to the lower frame section 64. It is contemplated that in other embodiments, there could be more or less than two idler wheel assemblies. In the present embodiment, the front and rear idler wheel assemblies 80, 82 aid in distributing borne load to the ground, and as such are support wheel assemblies 80, 82. It is contemplated that in some embodiments, the front and rear idler wheel assemblies 80, 82 could not be support wheel assemblies. The track system 50b also includes a tensioner 84 operatively connected to the front idler wheel assembly 80. The tensioner 84 is operable to change the tension in the endless track 100 by moving the front idler wheel assembly 80. It is contemplated that in some embodiments, the tensioner 84 could be connected to the rear idler wheel assembly 82. It is also contemplated that in some embodiments, the tensioner 84 could be omitted.

The track system 50b also has four support wheel assemblies 84a, 84b, 84c, 84d that are rotatably connected to the frame 62. More precisely, the four support wheel assemblies 84a, 84b, 84c, 84d are removably and rotationally connected to the lower frame section 64. It is contemplated that in some embodiments, there could be more or less than four support wheel assemblies. In the illustrated embodiment, the support wheel assemblies 84a, 84b, 84c, 84d are disposed between the lateral frame portions 66 on the left and right sides of the 64. The support wheel assemblies 84a, 84b, 84c, 84d will be described in greater detail below.

The track system 50b also includes the endless track 100, which surrounds the frame 62, the driving wheel assembly 70b, the front and rear idler wheel assemblies 80, 82 and the support wheel assemblies 84a, 84b, 84c, 84d. The endless track 100 is an elastomeric track. In the present embodiment, the endless track 100 is a polymeric track. The endless track 100 has an inner surface 102 and an outer surface 104.

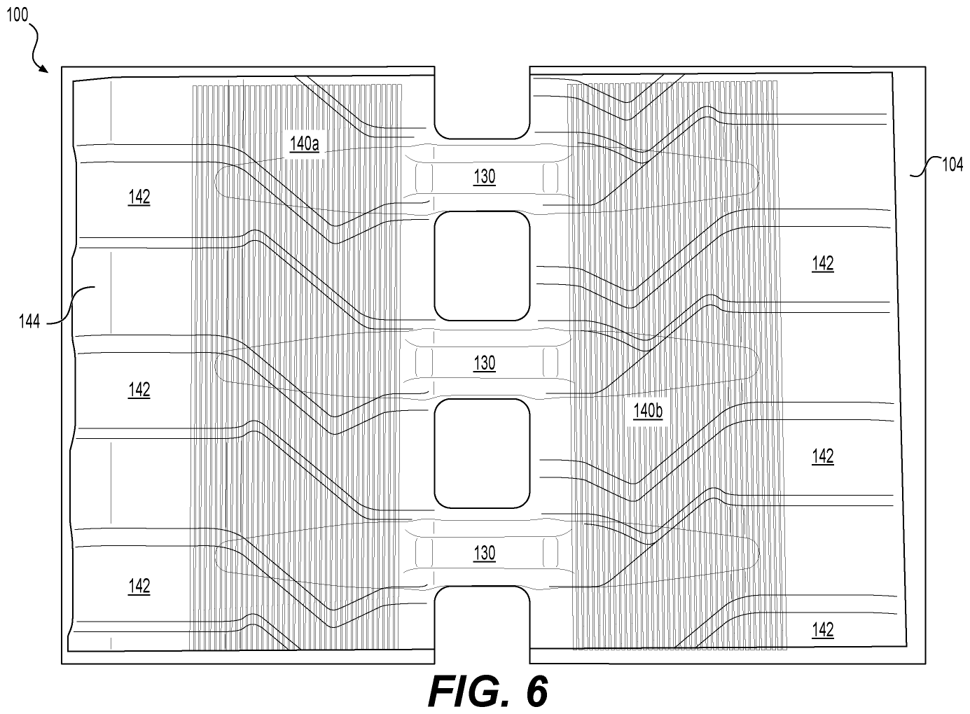

The inner surface 102 of the endless track 100 has a set of lugs 110. In the example of FIG. 2, the lugs 110 are positioned at a central portion of the inner surface 102. The lugs 110, which are longitudinally spaced along the endless track 100, are configured to engage with engagement members of the driving wheel assembly 70b. The outer surface 104 of the endless track 100 has a tread (tread lugs 142 are shown on FIG. 6) defined thereon.

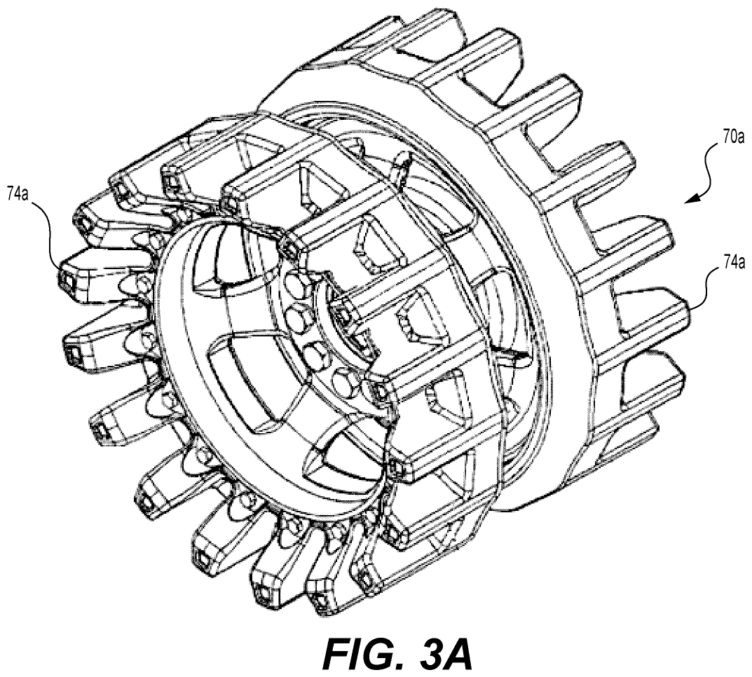

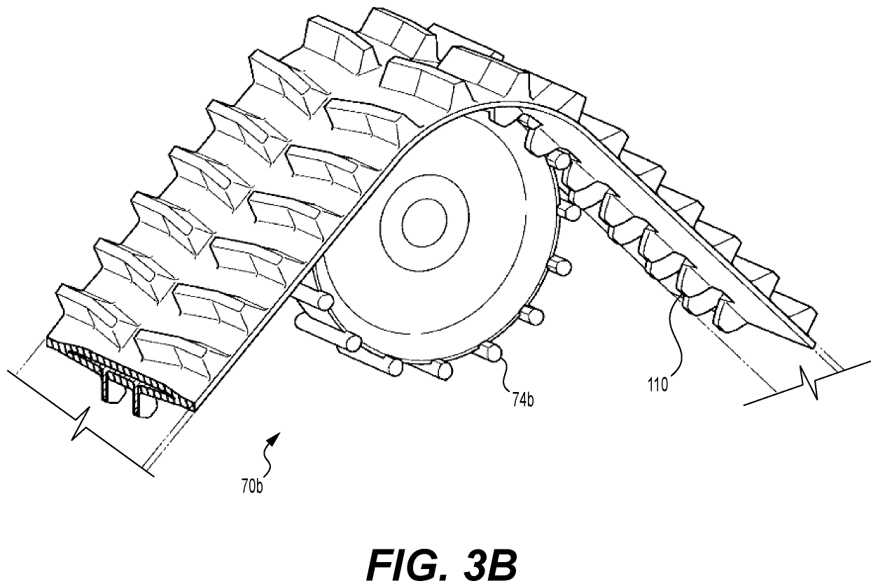

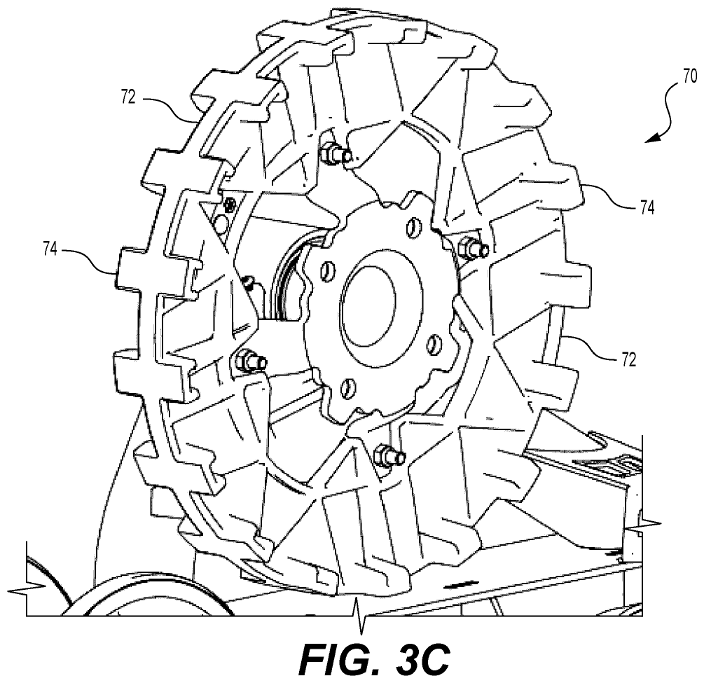

The track systems 50a, 50b, 501c and 502c each includes a respective driving wheel assembly configured to engage lugs 110 of the endless track 100. In particular, the track system 50a mounted on the military vehicle 40a has a driving wheel assembly 70a shown on FIG. 3a. The driving wheel assembly 70a has, on its outer periphery, a plurality of engagement members 74a that will engage the lugs 110 of the endless track 100 when the driving wheel assembly 70a is rotating. The track system 50b mounted on the compact track loader 40b has a driving wheel assembly 70b shown on FIG. 3b. Reinforcement members are also embedded in the endless track 100 of the track system 50b. The driving wheel assembly 70b has, on its outer periphery, a plurality of engagement members 74b that will engage the lugs 110 of the endless track 100 when the driving wheel assembly 70b is rotating. Each of the track systems 501c and 502c mounted on the ATV 40c has a driving wheel assembly 70c shown on FIG. 3c. The driving wheel assembly 70c has, on its outer periphery, a plurality of engagement members 74c that will engage the lugs 110 of the endless track 100 when the driving wheel assembly 70c is rotating.

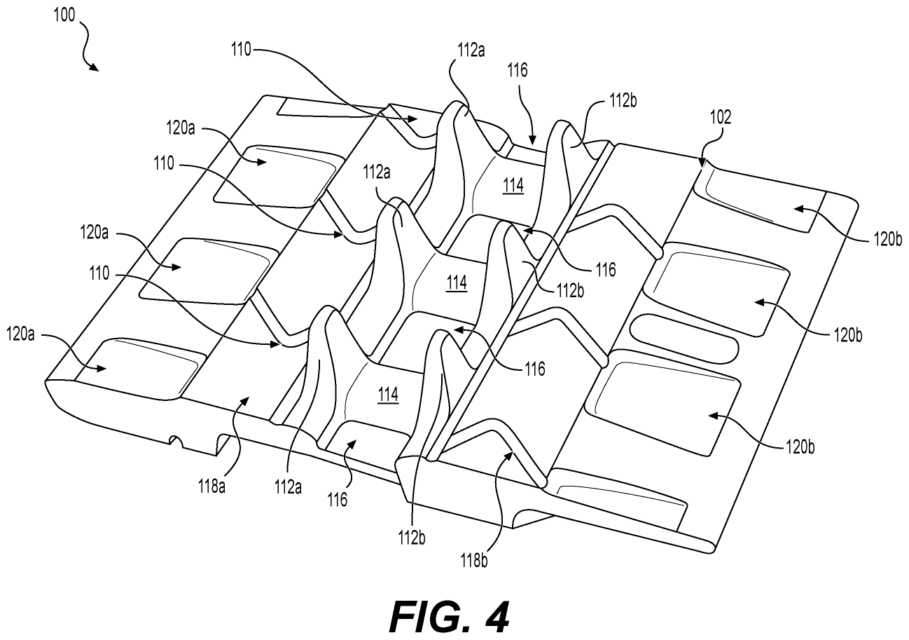

A portion of the endless track 100 will now be described in greater detail with reference to FIGS. 4 to 6. Generally speaking, the endless track 100 extends around components of the track system 50a, 50b, 50c, such that the endless track 100 surrounds the driving wheel assembly 70a, 70b, 70c, the frame 62, the front and rear idler wheel assemblies 80, 82, and the support wheel assemblies 84a, 84b, 84c, 84d. The carcass of endless track 100 has an inner surface 102 defining a set of longitudinally spaced lugs 110 disposed generally centrally along the endless track 100. A spacing between the lugs 110 substantially corresponds to a spacing between the engagement members 74a, 74b, 74c of the driving wheel assembly 70a, 70b, 70c. In the example of FIGS. 4 to 6, each lug 110 has two laterally spaced projections 112a, 112b that project from the inner surface 102, away from the outer surface 104 by an intermediate segment 114 that connects the two projections 112a, 112b. In a non-limiting embodiment, the open space defined between the two projections 112a, 112b allows the projecting members 74a of the driving wheel assembly 70a to apply pressure directly on a reinforcement member 130 embedded in the endless track 100. It is contemplated that each lug 110 may comprise a single, centrally positioned projection instead of the two projections 112a, 112b. In other words, the endless track 100 may have a single projection extending from the inner surface 102 and longitudinally spaced from each other, for example and without limitation when the driving wheel assembly 70b (FIG. 3b) is used.

As mentioned previously, the engaging members 74a, 74b, 74c of the driving wheel assembly 70a, 70b, 70c are configured to engage with the lugs 110 of the endless track 100 in different manners, depending on the driving configuration between the endless track 100 and the driving wheel assembly 70a, 70b, 70c.

In some embodiments, the endless track 100 may further define a plurality of recesses 116. More precisely, each one of the plurality of recesses 116 extends between two adjacent intermediate segments 114 such that the recesses 116 are longitudinally spaced from one another. Thus, the engaging members 74a, 74b, 74c are configured to drive the intermediate segment 114 between both projections 112a, 112b of the endless track 100, extending at least partially through the plurality of recesses 116.

In some embodiments, the engaging members 74a, 74b, 74c of the driving wheel assembly 70a, 70b, 70c are configured to engage with the pairs of projections 112a, 112b to drive the endless track 100. It is contemplated that in some embodiments, the recesses 116 could be omitted.

On each lateral side of the lugs 110, the inner surface 102 has wheel engaging sections 118a, 118b, commonly known as “wheel paths”. The wheel engaging sections 118a, 118b, which extend longitudinally along the endless track 100, are generally flat. The wheel engaging sections 118a, 118b are configured to engage with the front and rear idler wheel assemblies 80, 82 and with the support wheel assemblies 84a, 84b, 84c, 84d. Still on the inner surface 102, laterally outwardly from the wheel engaging section 118a, the endless track 100 defines a plurality of longitudinally spaced recesses 120a. Similarly, laterally outwardly from the wheel engaging section 118b, the endless track 100 defines a plurality of longitudinally spaced recesses 120b. The recesses 120a are longitudinally aligned with the recesses 120b. In addition, the recesses 120a, 120b are aligned with the recesses 116. In some embodiments, the recesses 120a could not be aligned with the recesses 120b. In other embodiments, the recesses 120a, 120b could not be aligned with the recesses 116. The recesses 120a, 120b and the recesses 116 reduce the amount of material required to manufacture the endless track 100. This reduction of material within the endless track 100 can, in some instances, help to reduce the rolling resistance of the endless track 100. In some cases, the recesses 120a, 120b may help in evacuating debris captured in the endless track 100 in operation.

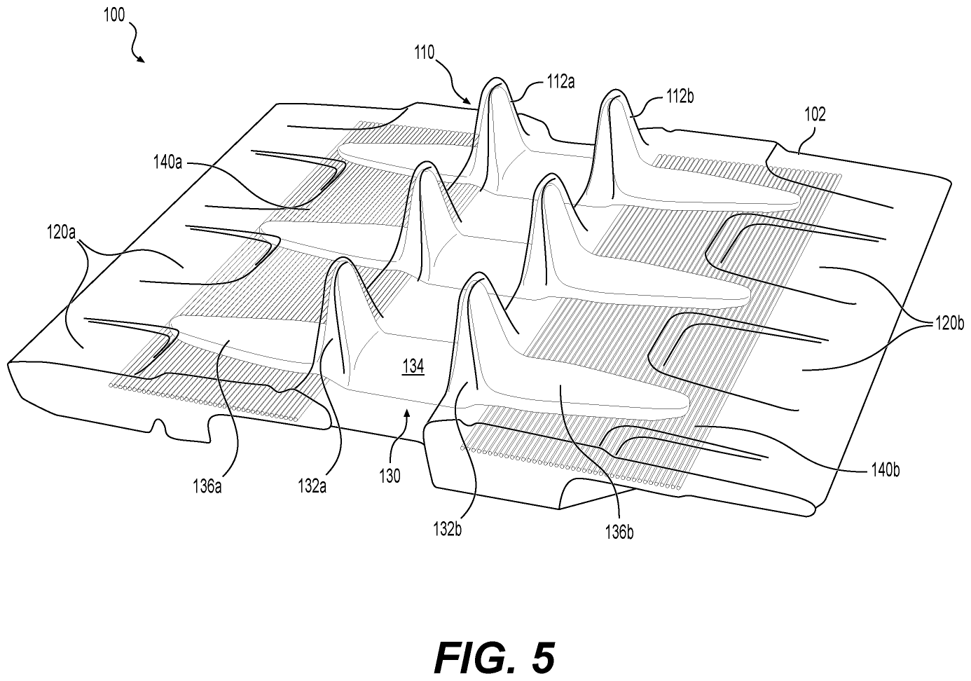

Referring to FIG. 5, the internal structure of the endless track 100 will now be described in greater detail. The endless track 100 (shown in transparency) has a plurality of longitudinally spaced reinforcement members 130 embedded within the endless track 100. Each one of the reinforcement members 130 is aligned with one of the lugs 110. As identical reinforcement members 130 may be disposed along the endless track 100, only one will be described in detail herewith. The reinforcement member 130 has two side protrusions 132a, 132b and an intermediate link 134. The side protrusion 132a is enclosed in the projection 112a, the intermediate link 134 is enclosed in the intermediate segment 114 and the side protrusion 132b is enclosed in the projection 112b. The reinforcement member 130 also has a lateral arm 136a that extends laterally outwardly from the side protrusion 132a, and a lateral arm 136b that extends laterally outwardly from the side protrusion 132b. Thus, the reinforcement members 130 are, in some embodiments, configured to have a shape similar to that of the lugs 110. In operation, in the non-limiting case of the driving wheel assembly 70a, the engagement members 74a reach in openings 133 defined between each intermediate segment 114 and apply their driving force on the endless track 100 at the level of the intermediate links 134 of the reinforcement members 130.

The recesses 120a (FIG. 4) are spaced such that of two adjacent recesses 120a, one recess 120a is disposed forwardly from the lateral arm 136a of a reinforcement member 130, and the other of the two adjacent recesses 120a is disposed rearwardly from that lateral arm 136a of the reinforcement member 130. Likewise, the recesses 120b (FIG. 4) are spaced such that of two adjacent recesses 120b, one recess 120b is disposed forwardly from the lateral arm 136b of a reinforcement member 130, and the other of the two adjacent recesses 120b is disposed rearwardly from the lateral arm 136b of that reinforcement member 130.

The reinforcement members 130 can help to transmit motion imparted on the endless track 100 by the engaging members 74a, 74b, 74c of the driving wheel assembly 70a, 70b, 70c. In addition, the reinforcement members 130 reinforce the lugs 110. As such, when the driving wheel assembly 70a, 70b, 70c engages the lugs 110 and/or when one or more of the front and rear idler wheel assemblies 80, 82 and the support wheel assemblies 84a, 84b, 84c, 84d engage the inner surface 102 the endless track 100, the endless track 100 is less likely to tear and/or to be damaged. Thus, a life of the endless track 100 can be prolonged.

Still referring to FIG. 5, the endless track 100 may also have two belting members 140a, 140b disposed within the endless track 100. The two belting members 140a, 140b extend longitudinally along the endless track 100, and further reinforce the endless track 100, while maintaining a nominal perimeter of the endless track 100 by minimizing its elongation.

Referring to FIG. 6, the outer surface 104 of the endless track 100 has tread lugs 142 that form a tread pattern 144 on the outer surface 104. It is contemplated that the tread pattern 144 could vary in shape and dimension from one embodiment to another. In some embodiments, the tread pattern 144 could depend on the type of vehicle on which the track systems 50a, 50b or 501c and 502c are to be used and/or the type of ground surface on which the vehicle is destined to travel. Spacing between tread lugs 142 can, to some extent, vary depending on the ground surface on which the endless track 100 is to be used, on the type of vehicle on which the endless track 100 is to be used, etc.

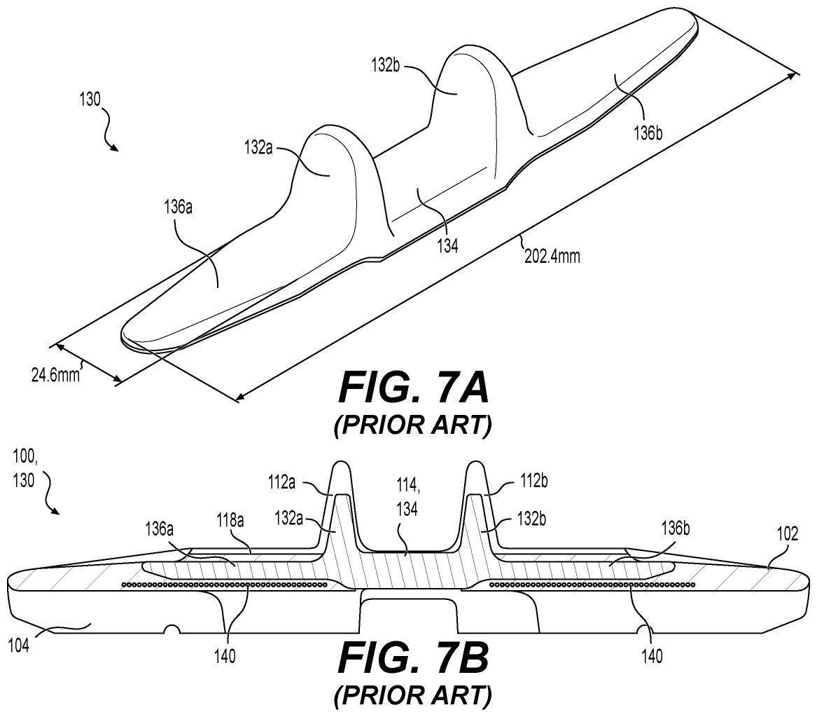

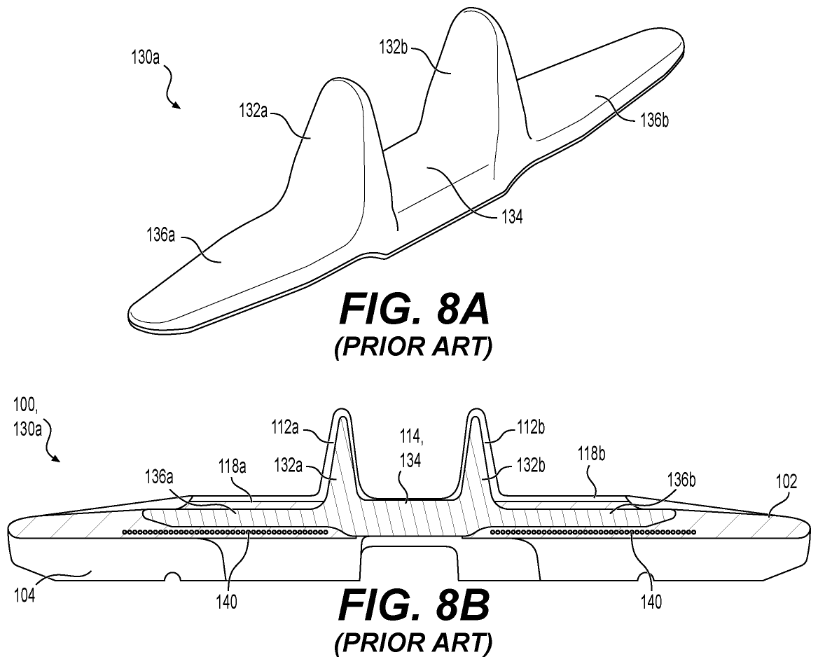

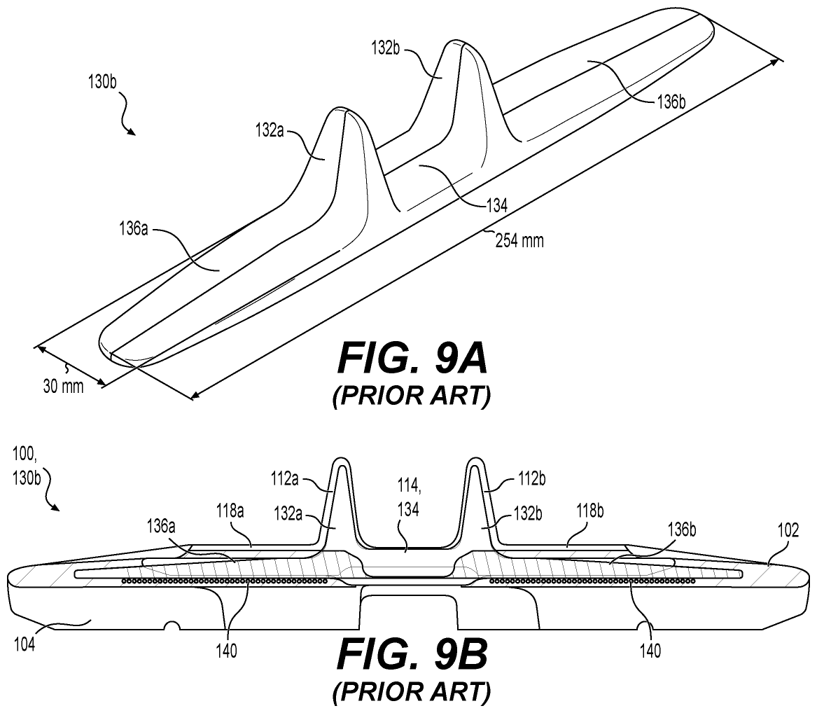

Referring to FIGS. 7a and 7b, a conventional reinforcement member 130 is shown alone (FIG. 7a) and embedded into the endless track 100 (FIG. 7b). FIGS. 8a and 8b show an alternate conventional reinforcement member 130a having longer protrusions 132. FIGS. 9a and 9b show another alternate conventional reinforcement member 130b being wider. The reinforcement member 130a as shown on FIGS. 8a and 8b is also visible in shadow form on FIG. 9b in order to better illustrate differences between the reinforcement members 130a and 130b; it should be understood that the reinforcement member 130a is not actually present in the endless track 100 as illustrated on FIG. 9b. Considering these Figures, various configurations of the reinforcement members 130, 130a, 130b may be provided to match various endless track configurations and/or to meet various requirements of the vehicle on which the endless track 100 is mounted. The reinforcement members 130, 130a and 130b as illustrated in FIGS. 5 to 9a and 9b are typically made of forged or casted steel. Although very resistant, the reinforcement member 130 limits the flexibility of the section of the endless track 100 in which it is embedded. Their weight increases the overall weight of the endless track 100 and thus the energy consumption of the vehicle on which the endless track 100 is mounted. In addition, in some cases, it may be desirable to have reinforcement member 130 that are more flexible to allow a lateral deformation of the endless track 100 (e.g. side-curb impact).

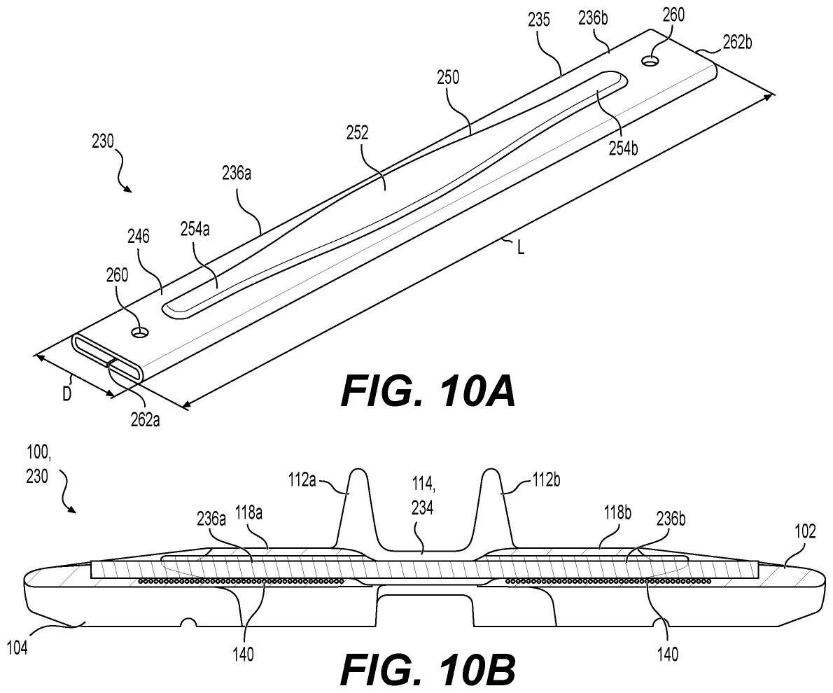

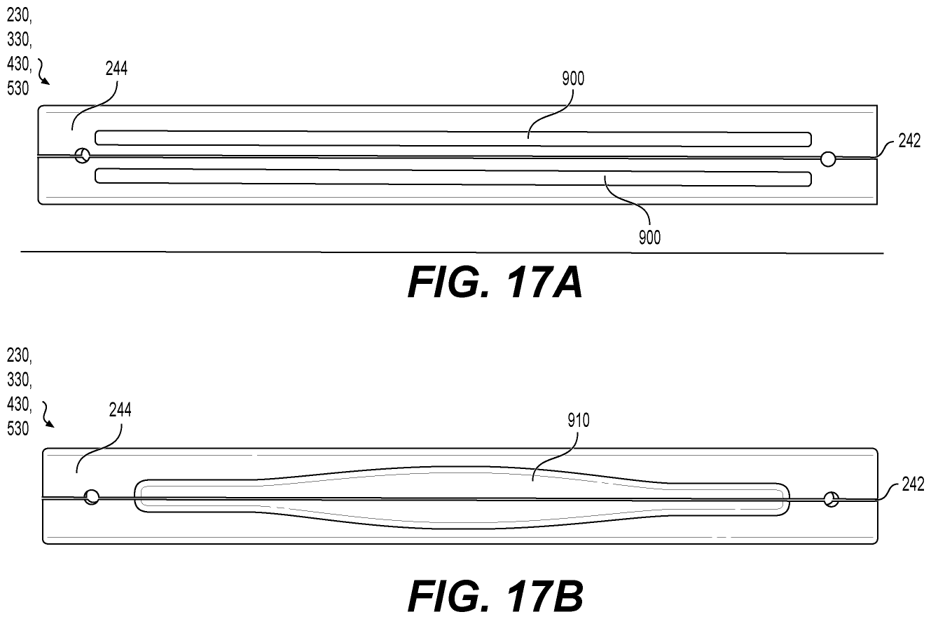

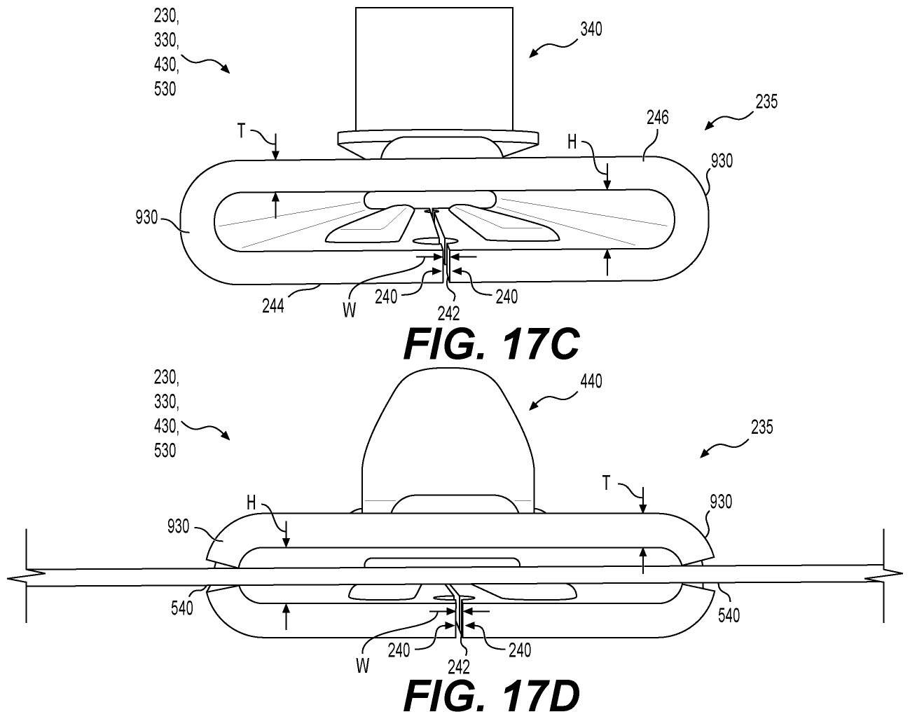

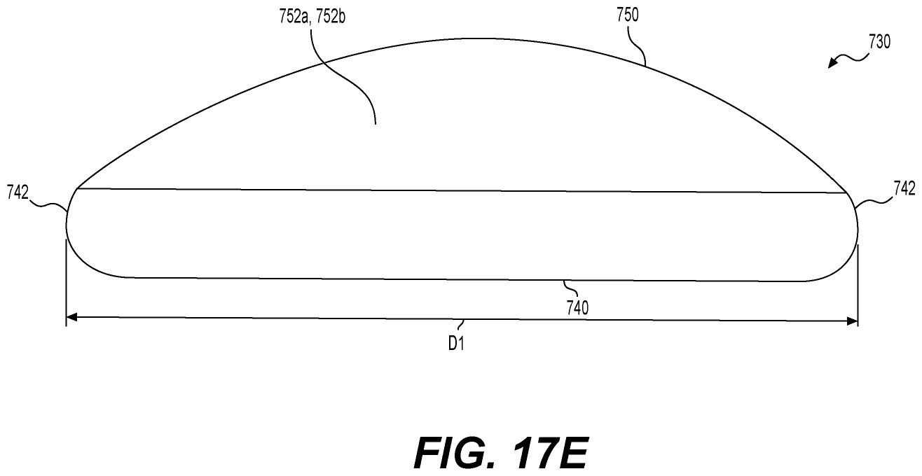

FIGS. 10a and 10b show a reinforcement member 230 in accordance with a first embodiment of the present disclosure, alone (FIG. 10a) and embedded into the endless track 100 (FIG. 10b). The reinforcement member 130a as shown on FIGS. 8a and 8b is also visible in shadow form on FIG. 10b in order to better illustrate differences between the reinforcement members 130a and 230; it should be understood that the reinforcement member 130a is not actually present in the endless track 100 as illustrated on FIG. 10b. The reinforcement member 230 comprises a flat, tubular and elongated body 235. The reinforcement member 230 may be formed by stamping a unitary metal sheet so that opposite long edges 240 (FIGS. 17c, 17d) of the metal sheet are brought in proximity to one another to form a junction 242 (visible on FIGS. 17c, 17d) on a lower face 244 of the reinforcement member 230. It is contemplated that the junction 242 may be elsewhere on the periphery of the elongated body 235 as well. For example and without limitation, the metal sheet may be formed of an aluminum coated, high strength steel alloy. A non-limiting example of such alloy providing reduced weight when compared to forged steel includes Usibor® 1500 from ArcelorMittal. Alternatively, the reinforcement member 230 may be extruded, in which case the long edges 240 and the junction 242 may be omitted.

The reinforcement member 230 has a central portion 234 and lateral arms 236a, 236b.

An elongated bulge 250 is formed on an upper face 246 of the reinforcement member 230, the upper face 246 being opposite from the lower face 244. Each of the lower and upper faces 244, 246 of the reinforcement member 230 forms a generally rectangular perimeter, each of the lower and upper faces 244, 246 having a depth D and a length L greater than the depth D. It is contemplated that the elongated bulge 250 may be replicated on the lower face 244 as well (elongated bulge 910 on FIG. 17b).

The elongated bulge 250 comprises a central portion 252, consistent with the central portion 234 of the reinforcement member 230. The central portion 252 of the elongated bulge 250 has a first width extending along a major portion of the depth D of the upper face 246 of the reinforcement member, and a pair of opposite ends 254a, 254b extending away from the central portion 252, a second width of the opposite ends 254a, 254b being smaller than the first width of the central portion 252. In the shown, non limiting embodiment, a perimeter of the elongated bulge 250 is tapered between the central portion 252 and each of the opposite ends 254a, 254b. It is understood that different shapes of elongated bulge are contemplated. For instance, each opposite ends 254a, 254b may converge to form a tip, assuring a progressive variation of inertia of section from the central portion 252 up to each tip.

In the non-limiting example of FIG. 10a, a pair of apertures 260 extend through the lower and upper faces 244, 246 of the reinforcement member 230. The apertures 260 are proximal to distal ends 262a, 262b of the reinforcement member 230, being located between opposite ends 254a, 254b of the elongated bulge 250 and the distal ends 262a, 262b of the reinforcement member 230 in the embodiment of FIG. 10a. In some cases, the apertures 260 may facilitate a flow of polymeric material inside and around the elongated body 235 during manufacturing of the endless track 100. In addition, the apertures 260 may enhance the connection of the reinforcement member 230 with the endless track 100 by providing mechanical interlocking relationship therebetween. It is understood that the apertures 260 may vary in shape, size, quantity, and location, depending on the cases.

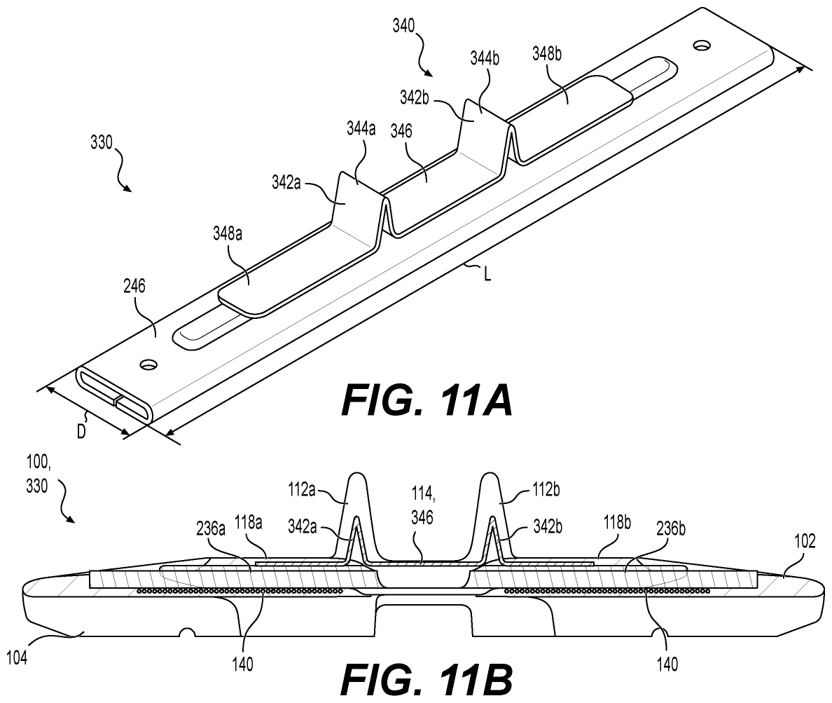

FIGS. 11a and 11b show a reinforcement member 330 in accordance with a second embodiment of the present disclosure, alone (FIG. 11a) and embedded into the endless track 100 (FIG. 11b). The reinforcement member 130a as shown on FIGS. 8a and 8b is also visible in shadow form on FIG. 11b in order to better illustrate differences between the reinforcement members 130a and 330; it should be understood that the reinforcement member 130a is not actually present in the endless track 100 as illustrated on FIG. 11b. The reinforcement member 330 may be constructed from the components of the reinforcement member 230. A description of those elements shared by the reinforcement members 230 and 330 is not repeated herein for brevity, noting however that modifications to the flat, tubular and elongated body 235 of FIG. 10a are contemplated. The reinforcement member 330 differs from the reinforcement member 230 by the addition of a plate 340 (namely referenced as a “clip”) mounted on top of the elongated bulge 250. The plate 340 defines protrusions 342a, 342b projecting vertically from the upper face 246 of the reinforcement member 330. The plate 340 may be formed by stamping a unitary metal plate so that each of the protrusions 342a, 342b has an inverted V-shape extending from flat sections 346, 348a and 348b of the plate 340. The protrusions 342a, 342b define peaks 344a, 344b that extend parallel to the depth D of the upper face 246 of the reinforcement member 330. In an embodiment, the two protrusions 342a, 342b are equidistant from a central position defined along the length L of the upper face 246 of the reinforcement member 330. The flat sections 346, 348a and 348b of the plate 340 other than the protrusions 342a, 342b may be connected to (e.g. by welding, by mechanical interlocking, etc.) or simply disposed on the upper face 246 of the reinforcement member 330. When simply disposed on the upper face 246, the polymeric material surrounding the reinforcement member 230 may be sufficient to maintain the plate 340 in place relative to the elongated body 235, while allowing a certain relative movement (or flexibility) therebetween.

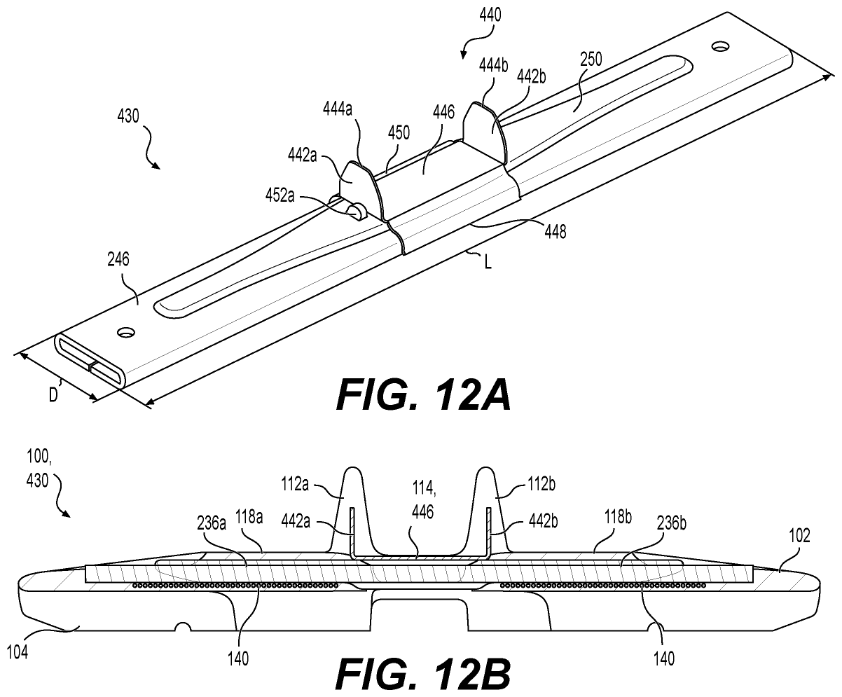

FIGS. 12a and 12b show a reinforcement member 430 in accordance with a third embodiment of the present disclosure, alone (FIG. 12a) and embedded into the endless track 100 (FIG. 12b). The reinforcement member 130a as shown on FIGS. 8a and 8b is also visible in shadow form on FIG. 12b in order to better illustrate differences between the reinforcement members 130a and 430; it should be understood that the reinforcement member 130a is not actually present in the endless track 100 as illustrated on FIG. 12b. The reinforcement member 430 may be constructed from the components of the reinforcement member 230. A description of those elements shared by the reinforcement members 230 and 430 is not repeated herein for brevity, noting however that modifications to the flat, tubular and elongated body 235 of FIG. 10a are contemplated. The reinforcement member 430 differs from the reinforcement member 230 by the addition of a plate 440 mounted on top of the elongated bulge 250. The plate 440 is mounted on top of the elongated bulge 250 and defines two protrusions 442a, 442b that project substantially vertically from the upper face of the reinforcement member 430 and define peaks 444a, 444b extending parallel to the depth D of the upper face 246 of the reinforcement member 430. The two protrusions 442a, 442b are equidistant from a central position defined along the length L of the upper face 246 of the reinforcement member 430.

In more details, the plate 440 is formed by stamping a unitary metal plate. A central portion 446 of the plate 440 is located on the central position defined along the length L of the upper face 246 of the reinforcement member 430. Two first opposite ends of the plate 440 are folded to form the two protrusions 442a, 442b projecting substantially vertically from the upper face 246 of the reinforcement member 430. Two second opposite ends 448, 450 of the metal plate 440 are curved to wrap around edges of the upper face 246 of the reinforcement member 430 toward the lower face 244 of the reinforcement member 430. The second two opposite ends 448, 450 of the plate 440 may be further curved to follow contours of the elongated bulge 250. It is understood that the curved ends 448, 450 form a mechanical interlocking relationship with the elongated body 235. In some cases, the plate 440 may be configured (e.g. pre-formed) to be installed as a “snap-fit” configuration. In some cases, the plate 440 may be partially configured to be disposed on the elongated body 235, prior to folding the ends 448, 450 around the elongated body 235 for securing the plate 440 in place.

In an embodiment, two stubs (only one stub 452a is shown) may be formed by raising portions of the metal sheet on the first elongated bulge 250, for instance. These two stubs may be placed to be in contact with external faces of the first two opposite ends of the metal plate 440 that form the two protrusions 432a, 432b for maintaining a position of the plate 440 on the reinforcement member 430.

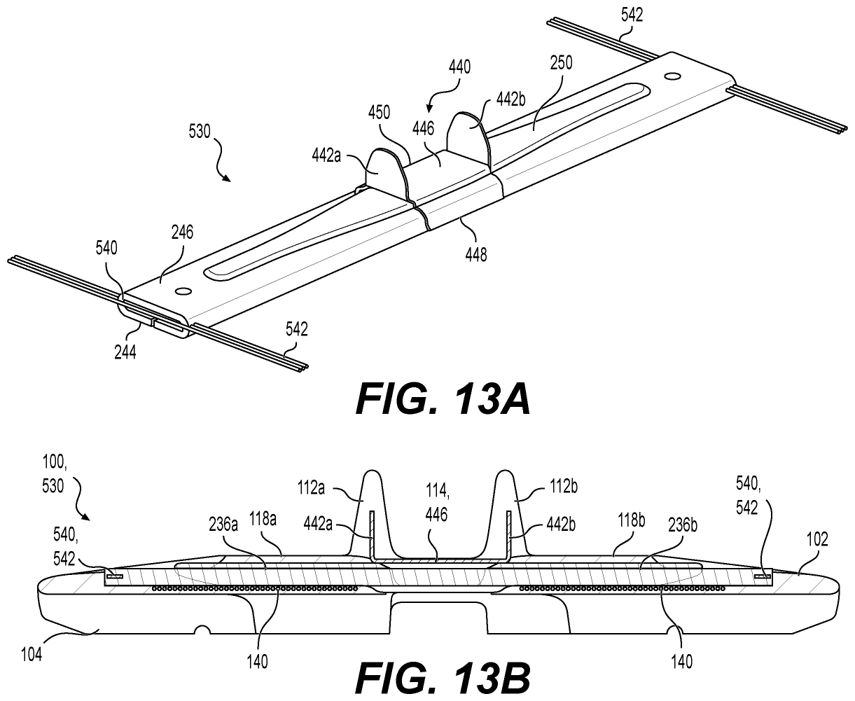

FIGS. 13a and 13b show a reinforcement member 530 in accordance with a fourth embodiment of the present disclosure, alone (FIG. 13a) and embedded into the endless track 100 (FIG. 13b). The reinforcement member 130a as shown on FIGS. 8a and 8b is also visible in shadow form on FIG. 13b in order to better illustrate differences between the reinforcement members 130a and 530; it should be understood that the reinforcement member 130a is not actually present in the endless track 100 as illustrated on FIG. 13b. The reinforcement member 530 may be constructed from the components of the reinforcement member 430. A description of those elements shared by the reinforcement members 430 and 530 is not repeated herein for brevity. The reinforcement member 530 differs from the reinforcement member 430 by the formation of slots 540 at each end of the reinforcement member 530, at a point where the lower and upper faces 244, 246 of the reinforcement member 530 meet. One or more reinforcing cables 542 extending parallel to the depth of the lower and upper faces 244, 246 of the reinforcement member 530 may be received in the slots 540 at each end of the reinforcement member 530. Forming similar slots for receiving similar cables on ends of the reinforcement members 230 or 330 is also contemplated. The at least one reinforcing cable 542 can be secured in the slots 540 by permanently deforming the elongated body 235 towards said cable 542 until the cable 542 are squeezed. Other joining methods are contemplated as well. Having at least one reinforcing cable 542 attached to the plurality of reinforcement members 235 along the endless track 100 may allow a load distribution of among adjacent reinforcement members 235 to reduce peak stresses and thus may prolong the life of the endless track 100.

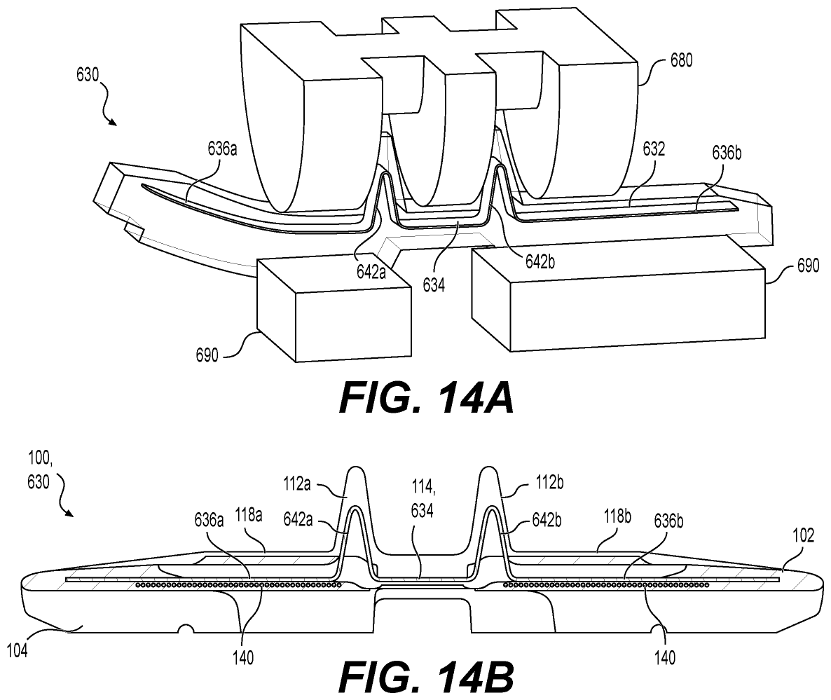

FIGS. 14a and 14b show a reinforcement member 630 in accordance with a fifth embodiment of the present disclosure. FIG. 14a schematically shows the reinforcement member 630 embedded into the endless track 100, with wheels 680 (e.g. the idler wheel assemblies 80, 82 and/or the support wheel assemblies 84a, 84b, 84c, 84d) applying their weights on the endless track 100 and obstacles 690 on a road surface (not shown) causing a lateral deformation of the endless track 100. FIG. 14b shows the reinforcement member 630 embedded into the endless track 100 at rest. The reinforcement member 130a as shown on FIGS. 8a and 8b is also visible in shadow form on FIG. 14b in order to better illustrate differences between the reinforcement members 130a and 630; it should be understood that the reinforcement member 130a is not actually present in the endless track 100 as illustrated on FIG. 14b.

The reinforcement member 630 comprises a thin elongated body. A major portion of the elongated body, including a central section 634 and lateral sections 636a, 636b are flat. Two protrusions 642a, 642b project substantially vertically from an upper face 632 of the elongated body. The reinforcement member 630 forms a generally rectangular perimeter, the upper face 632 of the reinforcement member 630 having a depth and a length greater than the depth, the protrusions 642a, 642b extending parallel to the depth of the upper face of the reinforcement member 640. The reinforcement member 630 is formed of a flexible material capable of elastic deformation. The reinforcement member 630 may be formed by stamping a unitary metal sheet (e.g. spring steel). Alternatively, the reinforcement member 630 may be formed of plastics (for example Ultra High Molecular Weight (UHMW) or other plastics), nylon, composites (for example fiber reinforced resin or other composites), rigid rubber, etc. As mentioned hereinabove, the endless track 100 may be mounted on various types of vehicles configured for light-duty, medium-duty or heavy-duty work, these vehicles handling varying load cases. The elastically deformable material used in forming the reinforcement member may be selected in accordance to an expected load case of a vehicle on which the endless track 100 is mounted. The material may also be selected as a function of dimensioning parameters of the endless track 100. As illustrated, the two protrusions 642a, 642b are equidistant from a central position defined along the length of the upper face of the reinforcement member 630.

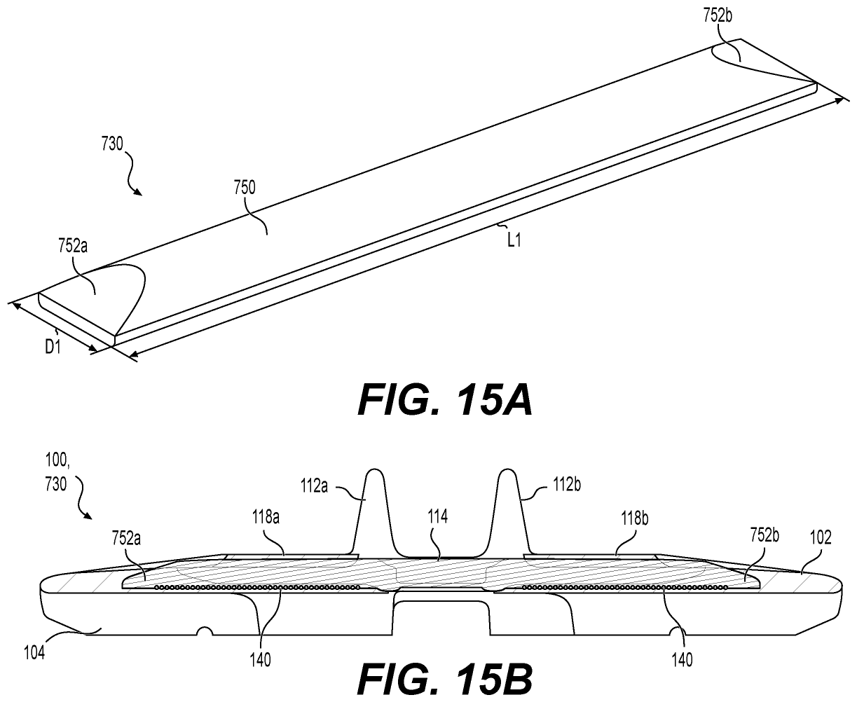

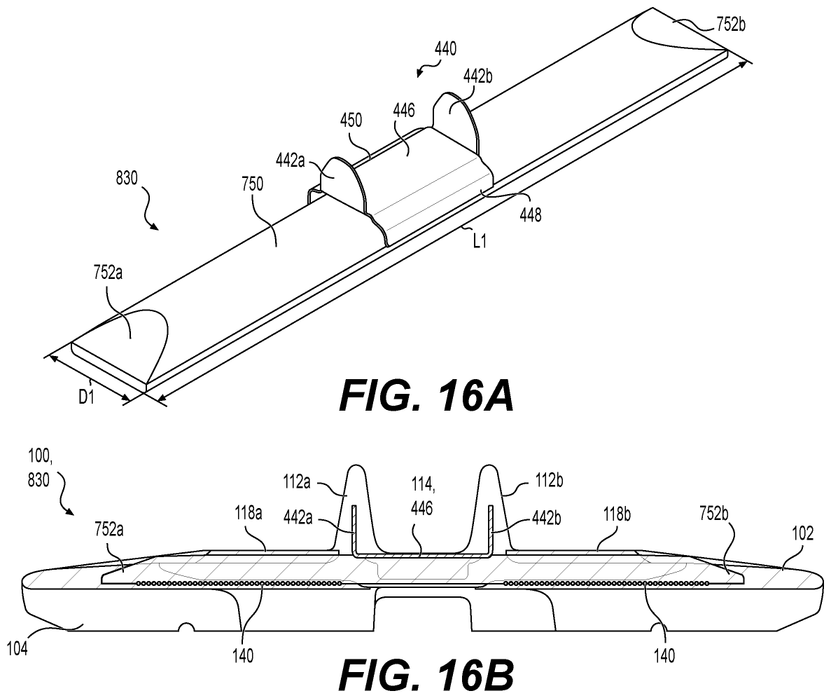

FIGS. 15a and 15b show a reinforcement member 730 in accordance with a sixth embodiment of the present disclosure, alone (FIG. 15a) and embedded into the endless track 100 (FIG. 15b). The reinforcement member 130a as shown on FIGS. 8a and 8b is also visible in shadow form on FIG. 15b in order to better illustrate differences between the reinforcement members 130a and 730; it should be understood that the reinforcement member 130a is not actually present in the endless track 100 as illustrated on FIG. 15b. The reinforcement member 730 comprises an elongated body forming a generally rectangular perimeter, the elongated body having a depth D1 and a length L1 greater than the depth D1. As best seen on FIG. 17e, a bottom section 740 of the reinforcement member 730 is generally flat with rounded elongated edges 742 defined along the length L1. A top section 750 of the reinforcement member 730 has a convex outline defined along the depth D1. Returning to FIG. 16a, the top section 750 of the reinforcement member 730 is tapered at opposite ends 752a, 752b of the reinforcement member 730. In one embodiment, the reinforcement member 730 is made of a composite material (e.g. fiber reinforced resin). In other embodiments, the reinforcement member 730 is made of a first material and a second material different from the first material. For example and without limitation, the bottom section 740 may be made of a metallic material (e.g. steel, aluminum, etc.) and the top section 750 may be made of a polymer (UHMW, nylon, etc.) or a composite material (fiber reinforced resin). A person skilled in the art will understand that different materials and combinations of first and second materials are contemplated, and different joining techniques for mating said first and second materials as well.

FIGS. 16a and 16b show a reinforcement member 830 in accordance with a seventh embodiment of the present disclosure, alone (FIG. 16a) and embedded into the endless track 100 (FIG. 16b). The reinforcement member 130a as shown on FIGS. 8a and 8b is also visible in shadow form on FIG. 16b in order to better illustrate differences between the reinforcement members 130a and 830; it should be understood that the reinforcement member 130a is not actually present in the endless track 100 as illustrated on FIG. 16b. The reinforcement member 830 may be constructed from the components of the reinforcement member 730. A description of those elements shared by the reinforcement members 730 and 830 is not repeated herein for brevity. The reinforcement member 830 differs from the reinforcement member 730 by the addition of the plate 440, which may be constructed as introduced in the description of FIG. 12a. The plate 440 may however differ slightly in that the second two opposite ends 448, 450 of the plate 440 may be further curved to follow contours of sides of the bottom and top sections 740, 750 of the reinforcement member 830, including the edges 742.

FIGS. 17a-17e show additional details of some embodiments of the reinforcement member. One or more or all of these details may be present in any one of the embodiments illustrated in FIGS. 10a, 11a, 12a, 13a, 15a and 16a.

As shown on FIG. 17a, in some embodiments, a pair of elongated grooves 900 may be formed on both sides of the junction 242, on the lower face 244 of any one of the reinforcement members 230, 330, 430 and 530. Alternatively, as shown on FIG. 17b, in some embodiments, a second elongated bulge 910 may be formed on the lower face 244 of any one of the reinforcement members 230, 330, 430 and 530. The second elongated bulge 910 may, for example and without limitation, have the same shape as the elongated bulge 250 present on the upper face 242 of any one of the reinforcement members 230, 330, 430 and 530, the second elongated bulge 910, however, being split in two halves by the junction 242.

In the embodiment shown on FIGS. 17c, 17d, the junction 242 forms a gap between the opposite long edges 240 of the metal sheet, a width W of the gap being less than a thickness T of the metal sheet. When the endless track 100 is manufactured, this gap may help a diffusion of the elastomeric material within an internal opening of the flat tubular and elongated body 235 formed between the lower and upper faces 244, 246 of the reinforcement members 230, 330, 430 or 530. A height H of the internal opening is in a range between one time and five times a thickness T of the metal sheet.

As best seen on FIG. 17c, the flat, tubular and elongated body 235 of any one of the reinforcement members 230, 330, 430 and 530 may define a pair of opposite curved and elongated surfaces 930 joining the lower and upper faces 244, 246 of any one of the reinforcement members 230, 330, 430 and 530.

FIG. 17d provides a detailed view of the slots 540 formed at an end of the reinforcement member 530, on the surfaces 920 joining the lower and upper faces 244, 246 of the reinforcement member 530, and of a reinforcing cable 542 inserted in the slots 540.

Although FIGS. 17c and 17d illustrate embodiments of the reinforcement member 230, 330, 430 or 530 having the grooves 900, the features shown on these Figures may be present in embodiments having the second elongated bulge 910 or having a flat lower face 244. Similarly, although FIG. 17c shows the plate 340 of FIG. 11a while FIG. 17d shows the plate 440 of FIG. 12a, the slots 540 may be formed in the flat, tubular and elongated body 235 of any one of the reinforcement members 230, 330, 430 and 530 for receiving the cables 542.

FIG. 17e shows a side elevation of the reinforcement member 730, with one of the taped ends 752a, 752b.

Considering now the vehicles of FIGS. 1a, 1b and 1c (or any other type of vehicle having an endless track), and considering the embodiments of FIG. 10a and of the following Figures, each reinforcement member 230, 330, 430, 530, 630, 730 or 830 is embedded in a carcass of the endless track 100, the length (e.g. L or L1) of the reinforcement member 230, 330, 430, 530, 630, 730 or 830 being oriented along a track width of the endless track 100. Each reinforcement member 230, 330, 430, 530, 630, 730 or 830 is aligned with a corresponding one of the one or more lugs.

Durability, flexibility, weight and size considerations may be met by selecting one or more of the various types of reinforcement members 230, 330, 430, 530, 630, 730 and 830 when constructing the endless track 100. For example, in some embodiments, the endless track 100 may be flexible across its width and each reinforcement member (for example and without limitation the reinforcement member 630) may be along the width of the endless track 100.

All of the above-described embodiments of the reinforcement members 230, 330, 430, 530, 630, 730 and 830 may be modified so that the reinforcement members 230, 330, 430, 530, 630, 730 and 830 may be integrated in an endless track in which each the lugs comprises a single, broader, central projection instead of the pair of projections 112a, 112b. Embodiments of the reinforcement members 230, 330, 430, 530, 630, 730 and 830 that include 342a, 342b, 442a, 442b or 642a, 642b may be modified to comprise a single, broader, central protrusion replacing the protrusions 342a, 342b, 442a, 442b or 642a, 642b. The reinforcement members may, in other embodiments, be disposed along the endless track 100 so that alternating reinforcement members include protrusions such as 342a or 342b, 442a or 442b, 642a or 642b, on the left side and then on the right side of the central position defined along the length L of the upper face 246 of the reinforcement members. Such endless tracks may be driven by drive wheel assemblies that are different from the sprocket-type driving wheel assemblies 70a, 70b, 70c of FIG. 3a, 3b, 3c. For example, such endless tracks may be driven by teeth that project from a circumference of a drive wheel and that transmit driving power on the central projections formed by the lugs of the endless track.

Modifications and improvements to the above-described embodiments of the present technology may become apparent to those skilled in the art. The foregoing description is intended to be exemplary rather than limiting.

What is claimed is:

1. A reinforcement member for an endless track, comprising:
a flat, tubular and elongated body having:
an upper face, a lower face opposite from the upper face, each of the upper and lower faces having a depth and a length greater than the depth,
a central portion and a lateral arm extending from each side thereof.

2. The reinforcement member of claim 1, wherein the reinforcement member is made of a metallic material.

3. The reinforcement member of claim 2, wherein the metallic material is one of aluminum and high strength steel alloy.

4. The reinforcement member of claim 2, wherein the reinforcement member is formed by stamping a unitary metal sheet so that opposite long edges of the metal sheet are brought in proximity to one another to form a junction along the length on the lower face of the reinforcement member.

5. The reinforcement member of claim 4, wherein the junction forms a gap between the opposite long edges of the metal sheet, a width of the gap being less than a thickness of the metal sheet.

6. (canceled)

7. The reinforcement member of claim 1, wherein at least one of the upper face and the lower face includes an elongated bulge.

8. The reinforcement member of claim 7, wherein the elongated bulge on the at least one of the upper face and the lower face comprises:
a central portion having a first width extending along a major portion of the depth of the upper or lower face of the reinforcement member; and
a pair of opposite ends extending away from the central portion, a second width of the opposite ends being smaller than the first width.

9. The reinforcement member of claim 8, wherein a perimeter of the elongated bulge on the at least one of the upper face and the lower face is tapered between the central portion and each of the opposite ends.

10. The reinforcement member of claim 9, wherein each of the opposite ends converges to form a tip.

11. (canceled)

12. The reinforcement member of claim 1, further comprising:
a pair of elongated grooves formed on both sides of the junction on the lower face of the reinforcement member.

13. The reinforcement member of claim 1, further comprising, a pair of apertures extending through the upper and lower faces of the reinforcement member, the apertures being located proximal to distal ends of the reinforcement member.

14. The reinforcement member of claim 1, wherein the flat, tubular and elongated body defines a pair of opposite curved and elongated surfaces joining the upper and lower faces of the reinforcement member.

15. The reinforcement member of claim 1, further comprising:
a plate disposed on top of the elongated body, the plate defining at least one protrusion projecting substantially vertically from the upper face of the reinforcement member, the at least one protrusion defining a peak extending parallel to the depth of the upper face of the reinforcement member.

16. The reinforcement member of claim 15, wherein the at least one protrusion comprises a single protrusion

17. The reinforcement member of claim 16, wherein the single protrusion is positioned centrally along a length of the upper face of the reinforcement member.

18. The reinforcement member of claim 16, wherein the single protrusion is positioned on a left or right side of a central position defined along a length of the upper face of the reinforcement member.

19. The reinforcement member of claim 15, wherein the at least one protrusion comprises two protrusions, the two protrusions being equidistant from a central position defined along a length of the upper face of the reinforcement member.

20. (canceled)

21. The reinforcement member of claim 15, wherein the plate is formed by stamping a unitary metal plate so that each of the at least one protrusion has an inverted V-shape extending from flat sections of the plate.

22. (canceled)

23. The reinforcement member of claim 15, wherein:
a central portion of the plate is located on a central position defined along the length of the upper face of the reinforcement member;
two first opposite ends of the plate are folded so that two protrusions project vertically from the upper face of the reinforcement member; and
two second opposite ends of the plate are curved to wrap around edges of the upper face of the reinforcement member toward the lower face of the reinforcement member.

24.-39. (canceled)

40. An endless track for a tracked vehicle, the track being disposed around at least a driving wheel assembly and a plurality of idler wheel assemblies, the endless track comprising:
an inner surface engageable by the driving wheel assembly and by the idler wheel assemblies,
an outer surface engageable to a ground surface,
one or more lugs projecting from the inner surface and configured to transmit driving power from the driving wheel assembly to the endless track, and
one or more reinforcement members as defined in claim 1, each reinforcement member being embedded in a carcass of the endless track, the length of the reinforcement member being oriented along a track width of the endless track, each reinforcement member being aligned with a corresponding one of the one or more lugs.

41.-44. (canceled)
